(19) United States
(12) Patent Application Publication
(10) Pub. No.: US 2016/0078534 A1
(43) Pub. Date: Mar. 17, 2016

(54) METHOD AND NETWORK FOR TRANSFERRING A LOAN

(71) Applicant: THE TORONTO-DOMINION BANK, Mississauga (CA)

(72) Inventors: Kurt A. SCHILLINGER, CLAWSON, MI (US); Kanthimathi CHANDAR, Bloomfield Hills, MI (US); Charles John ROBRECHT, III, Franklin, MI (US); Prabaharan SIVASHANMUGAM, Farmington Hills, MI (US)

(21) Appl. No.: 14/855,098

(22) Filed: Sep. 15, 2015

Related U.S. Application Data
(60) Provisional application No. 62/050,754, filed on Sep. 15, 2014.

(51) Int. Cl. G06Q 40/02

(52) U.S. Cl. CPC G06Q 40/025

(57) ABSTRACT

A method of transferring a loan involves a primary financial institution server receiving a credit application for a loan. The credit application includes credit application content and further includes credit application meta-data identifying particulars of the credit application. The credit application particulars includes a loan amount. The primary financial institution server is associated with a primary financial institution. The primary financial institution server determines from the credit application meta-data that the credit application is consistent with secondary credit risk requirements associated with a secondary financial institution, registers in a primary loans management database of the primary financial institution a loan in the loan amount, transmits the credit application content to a secondary financial institution server requesting assumption of the loan by the secondary financial institution, and advances funds in the loan amount. The secondary financial institution server is associated with the secondary financial institution.

### RELATED APPLICATIONS

This patent application claims the benefit of the filing date of U.S. Provisional Patent Application Ser. No. 62/050,754, filed Sep. 15, 2014, entitled “System and Method for Financing a Loan”.

### FIELD OF THE INVENTION

This patent application relates to a method and network for processing a credit application.

### BACKGROUND

To facilitate the purchase of new automobiles, an automobile manufacturer may have a direct relationship arrangement with a finance company (“captive lender”) that provides financing to customers who purchase automobiles from the manufacturer's network of automobile dealers. In such a direct financing model, the dealer delivers the customer's credit application to the captive lender, which then provides the requested funds to the dealer after confirming that the credit risk of the customer is consistent with the risk requirements of the captive lender.

The captive lender may be unable to approve the loan on the terms identified in the credit application, and the dealer may deliver the customer's credit application to a finance broker that itself has relationships with various financial institutions. In such an indirect financing model, the finance broker selects one of the financial institutions to provide the financing, based on the terms of the loan requested and the risk requirements of each financial institution. The financial institution notifies the finance broker of its approval of the credit application after confirming that the credit risk of the customer is consistent with the risk requirements of the financial institution.

Since the financial institution must approve the credit application before it validates the stipulations of the financial institution (e.g. income statements, wealth reports, asset valuation), the financial institution may end up with a loan registered on its books even though the loan is inconsistent with the internal funding policies of the financial institution.

### SUMMARY

This patent application discloses a loan transfer network and an associated method of transferring a loan.

In accordance with a first aspect of the disclosure, there is provided a method of transferring a loan that involves a primary financial institution server receiving a credit application for a monetary loan to a credit applicant. The primary financial institution server is associated with a primary financial institution. The credit application includes credit application content and also includes credit application meta-data that identifies particulars of the credit application. The credit application particulars include a loan amount.

The primary financial institution server determines from the credit application meta-data whether the credit application is consistent with secondary credit risk requirements associated with a secondary financial institution. The secondary financial institution is distinct from the primary financial institution.

After determining from the credit application meta-data that the credit application is consistent with the secondary risk requirements, the primary financial institution server (i) registers in a primary loans management system of the primary financial institution a loan in the loan amount to the credit applicant, and (ii) transmits the credit application content to a secondary financial institution server requesting assumption of the loan by the secondary financial institution, and (iii) advances funds in the loan amount. The secondary financial institution server is associated with the secondary financial institution.

The method secondary financial institution server may determine from the credit application content that the credit application is consistent with secondary policy stipulations associated with the secondary financial institution, register the loan in a secondary loans management system of the secondary financial institution, and transmit to the primary financial institution server confirmation of the assumption of the loan by the secondary financial institution. The primary financial institution removes the loan from the primary loans management system in response to the confirmation.

In accordance with a second aspect of the disclosure, there is provided a loan transfer network that includes a primary financial institution server a secondary financial institution server. The primary financial institution server is associated with a primary financial institution, and is in communication with a primary loans management system. The secondary financial institution server is associated with a secondary financial institution.

The primary financial institution server is configured to receive a credit application for a monetary loan to a credit applicant. The credit application includes credit application content and also includes credit application meta-data that identifies particulars of the credit application. The credit application particulars include a loan amount.

The primary financial institution server is configured to determine from the credit application meta-data that the credit application is consistent with secondary credit risk requirements associated with the secondary financial institution, register in the primary loans management system a loan in the loan amount to the credit applicant, transmit the credit application content to the secondary financial institution server requesting an assumption of the loan by the secondary financial institution, and electronically transfer funds in the loan amount.

The secondary financial institution server is in communication with a secondary loans management system and may be configured to determine from the credit application content that the credit application is consistent with secondary policy stipulations associated with the secondary financial institution, register the loan in the secondary loans management system, and transmit to the primary financial institution server confirmation of the assumption of the loan by the secondary financial institution.

The primary financial institution server may be configured to remove the loan from the primary loans management system upon receipt of the confirmation.

Since the primary financial institution approves the loan if the credit application is consistent with the credit risk requirements of the secondary financial institution, the primary financial institution is able to quickly provide loan financing even if the credit application is inconsistent with the credit risk requirements of the primary financial institution. Further, since the secondary financial institution only assumes the loan after the secondary financial institution server confirms that the credit application is consistent with the policy stipulations of the secondary financial institution, there is reduced likelihood of the secondary financial institution assuming an unwanted loan in contrast to the indirect financing model.

### BRIEF DESCRIPTION OF THE DRAWINGS

An exemplary loan transfer network and method of financing a loan, will now be described, with reference to the accompanying drawings, in which:

FIG. 1 is a schematic view of the loan transfer network, depicting an electronic document processing server, a communications terminal, a primary financial institution server, and a secondary financial institution server;

FIG. 2 is a schematic view of the electronic document processing server;

FIG. 3 is a schematic view of the primary financial institution server;

FIG. 4 is a schematic view of the secondary financial institution server; and

FIG. 5 is a message flow diagram depicting the method of financing a loan.

### DETAILED DESCRIPTION

### Loan Transfer Network

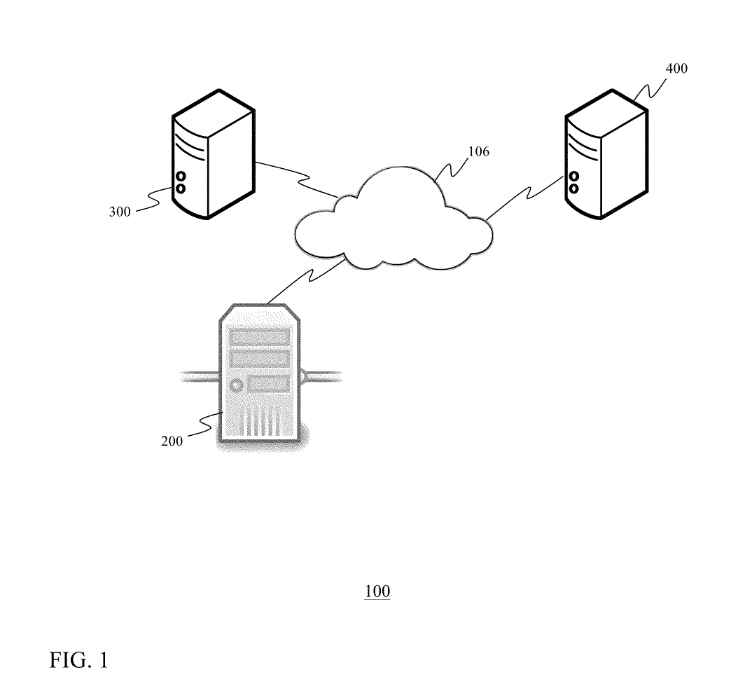

FIG. 1 is a schematic view of a loan transfer network, denoted generally as 100. As shown, the loan transfer network 100 comprises a document processing server 200, a primary financial institution server 300, a secondary financial institution server 400, and a communications network 106 that interconnects the document processing server 200, the primary financial institution server 300, and the secondary financial institution server 400. The communications network 106 may be implemented as a wireline wide area network (e.g. the Internet). Further, as will be discussed below, the communications network 106 may be implemented as, or include, a wireless wide area communications network.

Although the loan transfer network 100 is shown comprising only a single document processing server 200, a single primary financial institution server 300, and a single secondary financial institution server 400, the loan transfer network 100 may include a plurality of the document processing servers 200, primary financial institution servers 300, and/or secondary financial institution servers 400.

As will be discussed in detail below, each primary financial institution server 300 is associated with a respective primary financial institution, and the operator of the document processing server 200 may receive a physical credit application document for a loan and may use the document processing server 200 to transmit to the primary financial institution server(s) 300, via the communications network 106, a credit application payload that includes credit application content and also includes credit application meta-data representative of information contained on the physical credit application document.

Each secondary financial institution server 400 is associated with a respective secondary financial institution. The primary financial institution server 300 advances the funds for the loan and directs the credit application content to one of the secondary financial institution servers 400 if the credit application meta-data is consistent with risk requirements of the associated secondary financial institution. The secondary financial institution server 400 assumes the loan approved by the primary financial institution if the credit application content is consistent with policy stipulations of the secondary financial institution.

### Document Processing Server

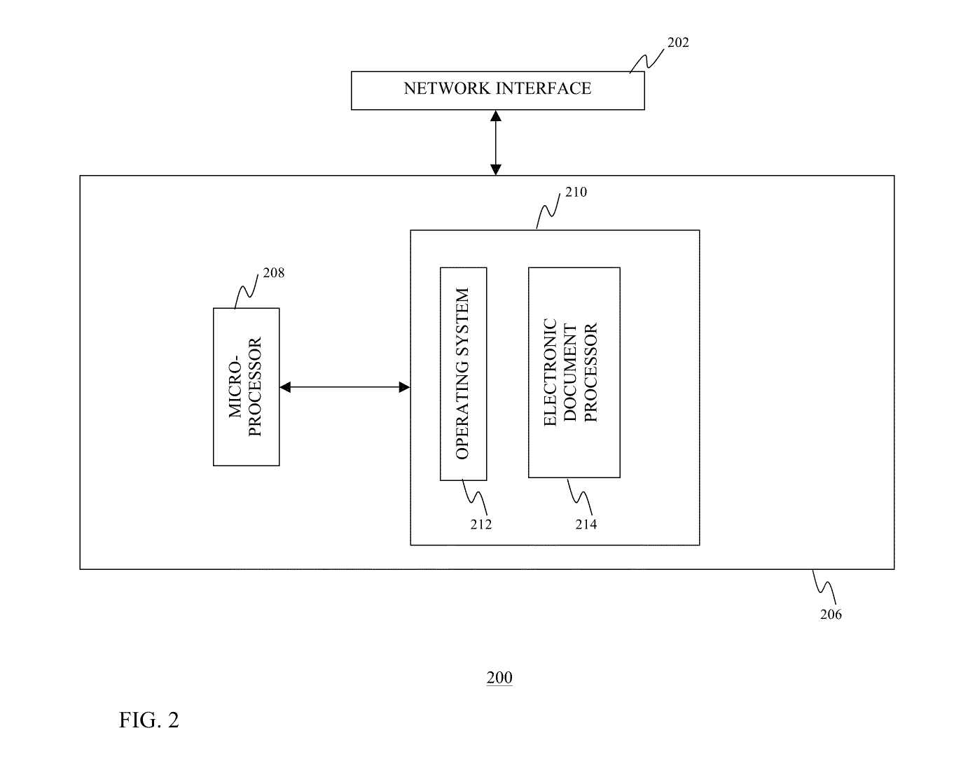

A sample document processing server 200 is depicted in FIG. 2. As shown, the document processing server 200 includes a network interface 202, and a data processing system 206 that is coupled to the network interface 202. The network interface 202 interfaces the document processor 200 with the communications network 106 to allow the electronic document processor 200 to communicate with the primary financial institution server(s) 300 via the communications network 106.

The data processing system 206 may include one or more microprocessors 208 and a non-transient computer-readable medium 210. The computer-readable medium 210 may be provided as electronic computer memory (e.g. flash memory) or optical or magnetic memory (e.g. compact disc, hard disk).

The computer-readable medium 210 includes computer processing instructions stored thereon which, when executed by the microprocessor(s) 208, implement an operating system 212 and an electronic document processor 214. The operating system 212 controls the overall operation of the document processing server 200, and allows the document processing server 200 to send and receive data over the communications network 106.

The electronic document processor 214 is configured to extract credit application meta-data from a physical credit application document, derive credit application content from at least physical credit application supporting documents, generate a credit application payload that includes the credit application content and the credit application meta-data, and electronically transmit the credit application payload to one of the primary financial institution servers 300, via the communications network 106.

Typically, the physical credit application document shows at least the applicant's name, address and tax authority identification number, and the loan amount requested by the credit applicant. The credit application supporting documents may include income statements, wealth reports, and asset valuation reports. Typically, the income statements, wealth reports, and asset valuation reports collectively show the applicant's taxable income, liabilities, monetary savings, investments and other assets, and the current estimated value of those liabilities, investments and other assets. Accordingly, the credit application meta-data extracted by the electronic document processor 214 may identify the applicant's name, address and tax authority identification number, the requested loan amount, the applicant's taxable income, liabilities, monetary savings, and the current estimated value of the applicant's liabilities, investments, and other assets.

Further, the credit application content may comprise at least one credit application document image derived from the physical credit application supporting document(s) and optionally from the physical credit application document, and the electronic document processor 214 is configured to derive the credit application document image(s) from the physical credit application supporting document(s) and optionally the physical credit application document. Alternately, or additionally, the credit application content may comprise credit application fingerprints (e.g. hash codes) that are derived from and uniquely identify the physical credit application supporting document(s) and optionally the physical credit application document, and the electronic document processor 214 may be configured to derive the credit application fingerprints from the physical credit application supporting document(s) and optionally the physical credit application document.

### Primary Financial Institution Server

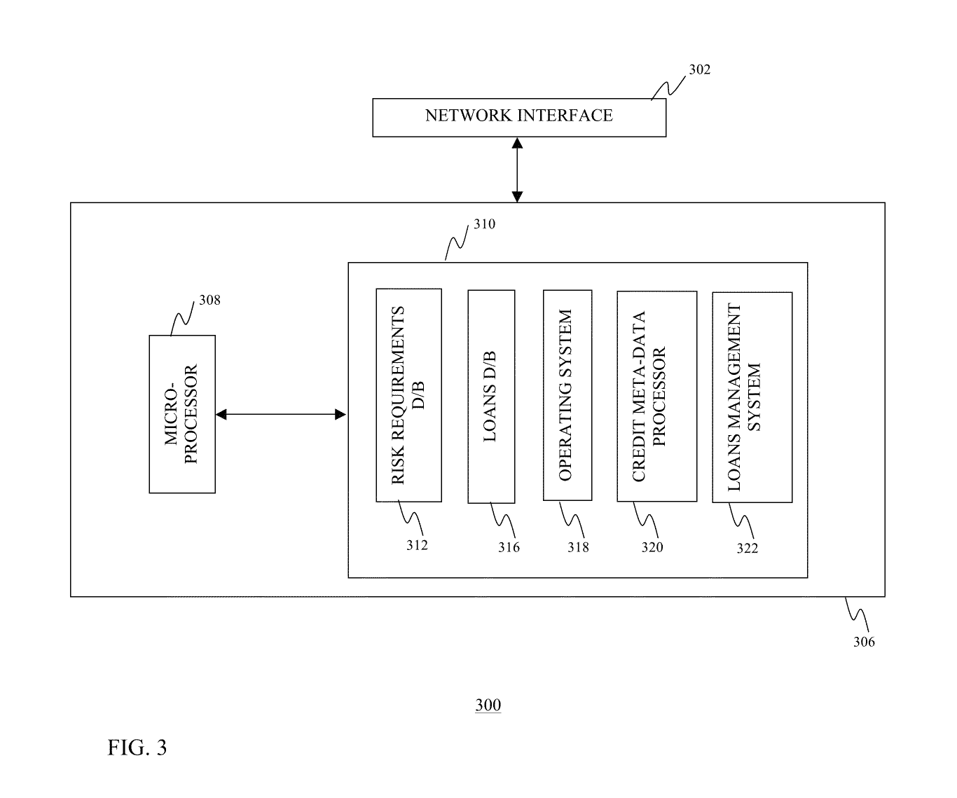

A sample primary financial institution server 300 is depicted in FIG. 3. As shown, the primary financial institution server 300 includes a network interface 302, and a data processing system 306 that is coupled to the network interface 302. The network interface 302 interfaces the primary financial institution server 300 with the communications network 106 and allows the primary financial institution server 300 to communicate with the document processing server(s) 200 and the secondary financial institution server(s) 400.

The data processing system 306 may include one or more microprocessors 308 and a non-transient computer-readable medium 310. The non-transient computer-readable medium 310 may be provided as electronic computer memory (e.g. flash memory) or optical or magnetic memory (e.g. compact disc, hard disk). The computer-readable medium 310 may maintain a risk requirements database 312 and a primary loans database 316.

As discussed, each primary financial institution server 300 is associated with a respective financial institution. The risk requirements database 312 saves credit risk requirements (primary credit risk requirements) that the primary financial institution requires to be met before the primary financial institution will provide a loan to a credit applicant.

The primary financial institution may have a loan assumption agreement with one or more secondary financial institutions that are able to provide more attractive loan financing (e.g. lower interest rates, longer term) than the primary financial institution is authorized to provide. Pursuant to the loan assumption agreement, the secondary financial institution may agree to assume a loan that was authorized by the primary financial institution (i.e. purchase the loan from the primary financial institution such that the credit applicant would be liable directly to the secondary financial institution for repayment of the loan), provided that the credit application for the loan was consistent with the credit risk requirements and the policy stipulations of the secondary financial institution.

Accordingly, the risk requirements database 312 may also save credit risk requirements (secondary credit risk requirements) that each secondary financial institution requires to be met before the secondary financial institution will provide a loan to a credit applicant. As non-limiting examples, the primary and secondary credit risk requirements saved in the risk requirements database 312 may include the minimum credit score the credit applicant must possess, and the maximum permitted number of instances that the credit applicant may be late in making a bill payment.

The non-transient computer-readable medium 310 also maintains computer processing instructions stored thereon which, when executed by the microprocessor(s) 308, define an operating system 318 that controls the overall operation of the primary financial institution server 300. The computer processing instructions stored in the computer-readable medium 310 may also implement a primary credit meta-data processor 320, and a primary loans management system 322.

The primary credit meta-data processor 320 is configured to (i) receive a credit application payload for a monetary loan to a credit applicant. The credit application payload includes credit application content and further includes credit application meta-data. The credit application meta-data specifies at least the requested loan amount. As discussed, the credit application meta-data may also identify the applicant's name, address and tax authority identification number, the applicant's taxable income, liabilities, monetary savings, and the current estimated value of the applicant's liabilities, investments, and other assets.

The primary credit meta-data processor 320 is configured to (ii) determine from the received credit application meta-data that the associated credit application is consistent with secondary credit risk requirements specified by the secondary financial institution. As discussed, the secondary credit risk requirements are maintained in the risk requirements database 312.

The primary loans management system 322 maintains, in the primary loans database 316, particulars of all the loans that have been approved by the primary financial institution and which have not yet been discharged or assumed by the secondary financial institution.

The primary credit meta-data processor 320 is also configured to (iii) register in the primary loans management system 322 a loan in the loan amount to the credit applicant, (iv) transmit the credit application content to the secondary financial institution server 400 requesting an assumption of the loan by the secondary financial institution, and (v) electronically transfer funds in the loan amount.

Although the primary credit meta-data processor 320 is typically implemented as computer processing instructions, all or a portion of the functionality of the primary credit meta-data processor 320 may be implemented instead in electronics hardware, such as a field programmable logic gate array (FPGA) or a complex programmable logic device (CPLD).

### Secondary Financial Institution Server

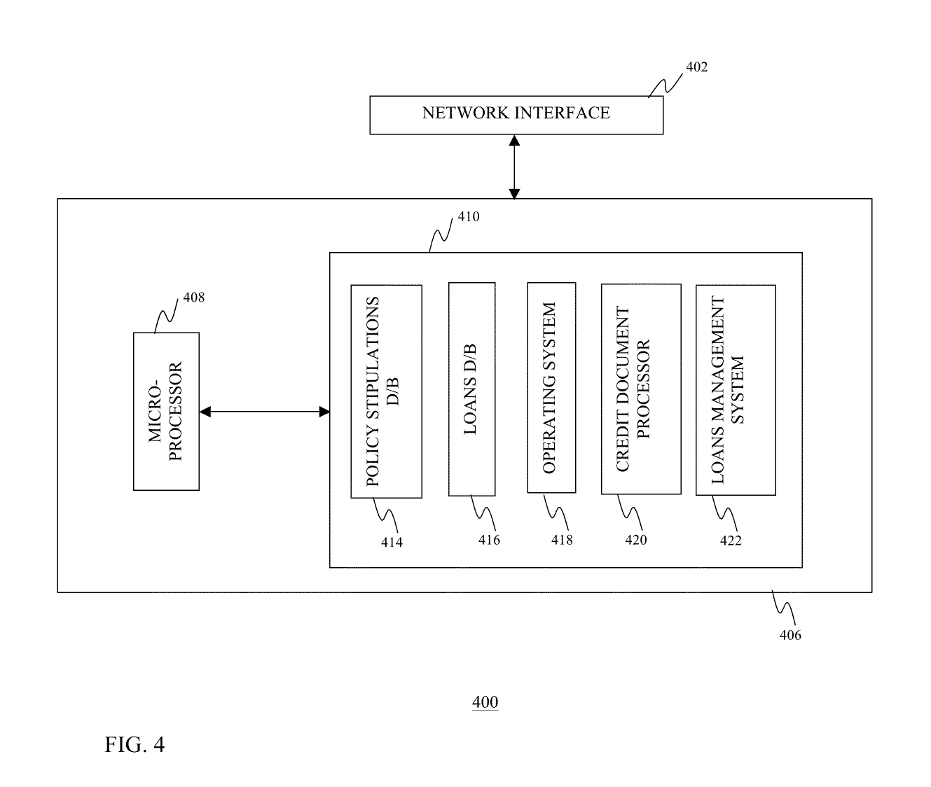

A sample secondary financial institution server 400 is depicted in FIG. 4. As shown, the secondary financial institution server 400 includes a network interface 402, and a data processing system 406 that is coupled to the network interface 402. The network interface 402 interfaces the secondary financial institution server 400 with the communications network 106 and allows the secondary financial institution server 400 to communicate with the primary financial institution server(s) 300.

The data processing system 406 may include one or more microprocessors 408 and a non-transient computer-readable medium 410. The non-transient computer-readable medium 410 may be provided as electronic computer memory (e.g. flash memory) or optical or magnetic memory (e.g. compact disc, hard disk). The computer-readable medium 410 may maintain a policy stipulations database 414, and a secondary loans database 416.

As discussed, each secondary financial institution server 400 is associated with a respective financial institution. The policy stipulations database 414 saves stipulations (i.e. credit application supporting documentation) that the associated secondary financial institution requires to be provided before the secondary financial institution will provide a loan to a credit applicant. As non-limiting examples, the stipulations may require the credit applicant to provide income statements summarizing the credit applicant's taxable income for one or more of the preceding taxation years, wealth reports summarizing the savings, investments, liabilities and assets of the credit applicant, and asset valuation reports summarizing the current estimated value of the investments, liabilities and assets of the credit applicant.

As discussed, the secondary financial institution may have a loan assumption agreement with one or more primary financial institutions, pursuant to which the secondary financial institution may agree to assume a loan that was authorized by the primary financial institution, provided that the credit application for the loan was consistent with the credit risk requirements and the policy stipulations of the secondary financial institution. Therefore, by implication, the stipulations saved in the policy stipulations database 414 specify the credit application supporting documentation that the associated secondary financial institution requires to be provided before the secondary financial institution will assume a loan authorized by the primary financial institution.

The non-transient computer-readable medium 410 also maintains computer processing instructions stored thereon which, when executed by the microprocessor(s) 408, define an operating system 418 that controls the overall operation of the secondary financial institution server 400. The computer processing instructions stored in the computer-readable medium 410 may also implement a secondary credit document processor 420, and a secondary loans management system 422.

The secondary credit document processor 420 is configured to (i) determine from credit application content received from one of the primary financial institution server(s) 300 that the credit application is consistent with the secondary policy stipulations of the secondary financial institution. As discussed, the secondary policy stipulations are maintained in the policy stipulations database 414.

Further, the credit application content may comprise at least one credit application document image derived from the credit application supporting document(s) and optionally the physical credit application document. Alternately, or additionally, the credit application content may comprise credit application fingerprints (e.g. hash codes) that are derived from and uniquely identify the physical credit application supporting document(s) and optionally the physical credit application document.

The second loans management system 422 maintains, in the secondary loans database 416, particulars of all the loans that have been approved or assumed by the secondary financial institution and which have not yet been discharged.

The secondary credit document processor 420 is also configured to (ii) register the loan in the secondary loans management system 422, and (iii) transmit to the primary financial institution server 300 confirmation of the assumption of the loan by the secondary financial institution.

Although the secondary credit document processor 420 is typically implemented as computer processing instructions, all or a portion of the functionality of the secondary credit document processor 420 may be implemented instead in electronics hardware, such as a field programmable logic gate array (FPGA) or a complex programmable logic device (CPLD).

### Method of Transferring a Loan

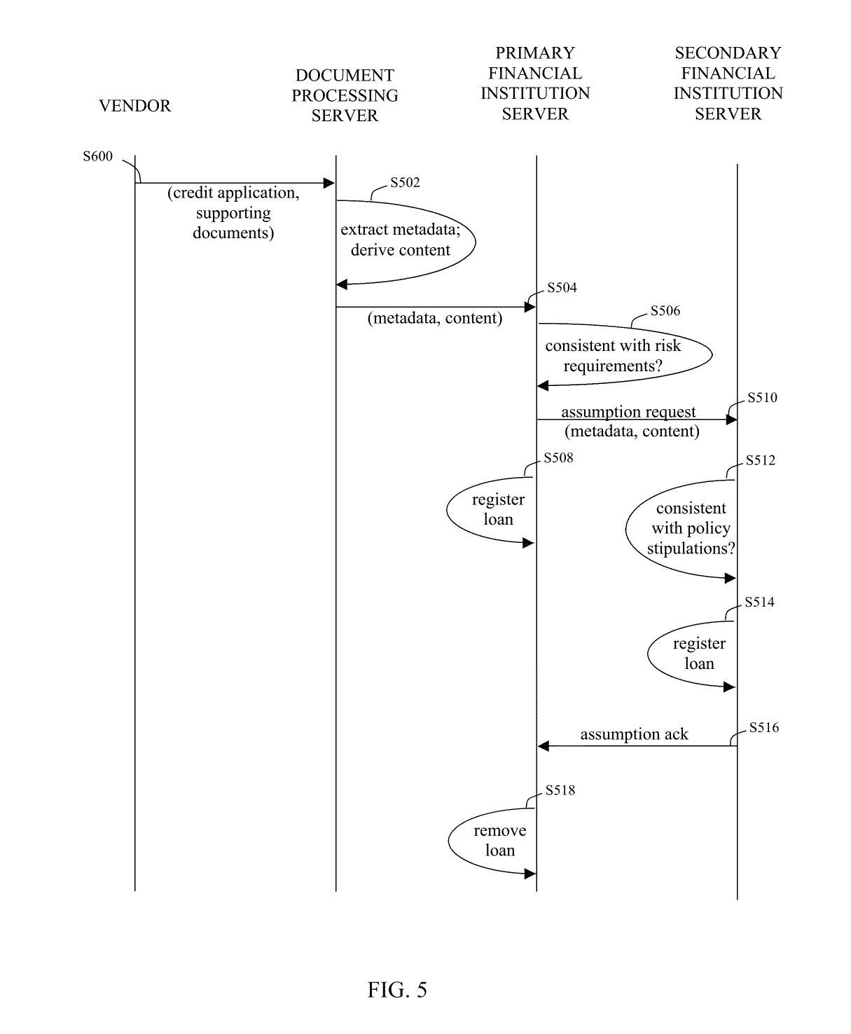

As discussed, the loan transfer network 100 implements a method of transferring a loan. A sample embodiment of the method is depicted in FIG. 5. As will be explained, in this embodiment a primary financial institution server 300 (associated with a primary financial institution) receives a credit application payload for a monetary loan to a credit applicant. The credit application payload includes credit application content and further includes credit application meta-data that specifies at least a loan amount.

The primary financial institution server 300 determines from the credit application meta-data whether the credit application is consistent with secondary credit risk requirements associated with a secondary financial institution. The secondary financial institution is associated with a secondary financial institution server and is distinct from the primary financial institution.

After determining from the credit application payload meta-data that the credit application is consistent with the secondary risk requirements, the primary financial institution server 300 (i) registers in the primary loans management system 322 of the primary financial institution a loan in the loan amount to the credit applicant, (ii) transmits the credit application content to the secondary financial institution server 400 requesting assumption of the loan by the secondary financial institution, and advances funds in the loan amount.

The secondary financial institution server 400 determines from the credit application content whether the credit application is consistent with the secondary policy stipulations of the secondary financial institution.

After determining from the credit application content that the credit application is consistent with the secondary policy stipulations, the secondary financial institution server 400 registers the loan in the secondary loans management system 422 of the secondary financial institution, and transmits to the primary financial institution server 300 confirmation of the assumption of the loan by the secondary financial institution. The primary financial institution server 300 removes the loan from the primary loans management system 322 in response to the confirmation.

An example of a method of transferring a loan will now be discussed in detail with reference to FIG. 5. At the outset of the method, a customer attends at the premises of an automobile dealer or other location where a customer requires a loan to complete the purchase of a vendor's products or services. To initiate the loan approval process, the customer (credit applicant) completes a paper-based credit application document and provides the vendor with the completed credit application document. The physical credit application document typically shows at least the applicant's name, address and tax authority identification number, and the loan amount requested by the credit applicant.

The vendor may then conduct a preliminary credit check of the credit applicant. To do so, the automobile dealer may access an online credit reporting agency and use the information provided on the credit application document to determine the credit score of the credit applicant.

If the credit applicant passes the preliminary credit check, the vendor may request that the credit applicant supply credit application supporting documents. The credit application supporting documents include, but are not limited to, income statements summarizing the credit applicant's taxable income for one or more of the preceding taxation years, wealth reports summarizing the liabilities, savings, investments and other assets of the credit applicant, and asset valuation reports summarizing the current estimated value of the liabilities, investments and other assets of the credit applicant.

After receiving the credit application supporting documents, at step S500 the vendor may deliver the physical credit application document and the physical credit application supporting documents to the operator of the document processing server 200. At step S502, the electronic document processor 214 derives credit application content from the physical credit supporting documents and optionally also the physical credit application document, extracts credit application meta-data from the physical credit application document, and generates a credit application payload that includes the credit application content and the credit application meta-data.

The credit application content may comprise one or more credit application document images, and the electronic document processor 214 may derive the credit application document images from the credit application supporting documents and optionally also the physical credit application document. Alternately, or additionally, the credit application content may comprise credit application fingerprints (e.g. hash codes) that are derived from and uniquely identify the physical credit application supporting document(s) and optionally the physical credit application document, and the electronic document processor 214 may derive the credit application fingerprints from the physical credit application supporting document(s) and optionally the physical credit application document, for example, by generating hash codes from information (e.g. document title, document date, monetary amounts) included in the documents.

The credit application meta-data includes, but is not limited to, the applicant's name, address and tax authority identification number, the requested loan amount, the applicant's taxable income, liabilities, monetary savings, and the current estimated value of the applicant's liabilities, investments, and other assets.

At step S504, the electronic document processor 214 electronically transmits the credit application payload to the primary financial institution server 300 of the primary financial institution typically used by the vendor, via the communications network 106.

As discussed, the primary financial institution may have executed a loan assumption agreement with one or more secondary financial institutions that are able to provide more attractive loan financing than the primary financial institution is authorized to provide. Pursuant to the loan assumption agreement, the secondary financial institution may agree to assume a loan that was authorized by the primary financial institution, provided that the credit application for the loan is consistent with the credit risk requirements and the policy stipulations of the secondary financial institution.

Therefore, at step S506, the primary credit meta-data processor 320 of the primary financial institution server 300 determines from the received credit application meta-data whether the credit application is consistent with the credit risk requirements of the secondary financial institution that is associated with the primary financial institution. To do so, the primary credit meta-data processor 320 may compare the received credit application meta-data with the secondary credit risk requirements of the secondary financial institution that are saved in the risk requirements database 312.

If the primary credit meta-data processor 320 determines from the credit application meta-data that the credit application is consistent with the secondary risk requirements of the secondary financial institution, the primary financial institution has, in effect, approved the loan. Therefore, at step S508 the primary credit meta-data processor 320 registers the loan with the primary loans management system 322 of the primary financial institution, preferably by providing the primary loans management system 322 with the credit application meta-data and the credit application content. The primary loans management system 322 saves the credit application meta-data and the credit application content in the primary loans database 316.

If the primary credit meta-data processor 320 determines from the credit application meta-data that the credit application is consistent with the secondary risk requirements of the secondary financial institution, the primary credit meta-data processor 320 also generates a loan assumption request message that preferably includes the credit application content and the credit application meta-data, and requests that the secondary financial institution assume the loan approved by the primary financial institution. At step S510, the primary credit meta-data processor 320 transmits the loan assumption request message to the secondary financial institution server 400 associated with the secondary financial institution, via the communications network 106.

The primary financial institution may then advance funds in the loan amount to the vendor. The primary credit meta-data processor 320 may initiate the funds transfer in the loan amount, for example, via an electronic funds transfer service, and may notify the vendor, for example, by e-mail, that the credit application has been approved.

At step S512, the secondary credit document processor 420 of the secondary financial institution server 400 determines from the received credit application content whether the credit application is consistent with the policy stipulations of the secondary financial institution. To do so, the secondary credit document processor 420 may compare the received credit application document image(s) and/or credit application fingerprints with the secondary policy stipulations of the secondary financial institution that are saved in the secondary policy database 412 to confirm, for example, that the secondary financial institution server 400 has received all credit application supporting documents required by the secondary financial institution.

If the secondary credit document processor 420 determines from the credit content that the credit application is consistent with the policy stipulations of the secondary financial institution, the secondary financial institution has, in effect, approved the loan. Therefore, at step S514 the secondary credit document processor 420 registers the loan with the secondary loans management system 422 of the secondary financial institution, for example, by providing the secondary loans management system 422 with the credit application content and the credit application meta-data. The secondary loans management system 422 saves the credit application content and the credit application meta-data in the secondary loans database 416.

If the secondary credit document processor 420 determines from the credit application content that the credit application is consistent with the policy stipulations of the secondary financial institution, the secondary credit document processor 420 also generates a loan assumption acknowledgment message that preferably includes both the credit application meta-data and the credit application content and confirms that the secondary financial institution has assumed the loan approved by the primary financial institution. At step S516, the secondary credit document processor 420 transmits the loan assumption acknowledgment message to the primary financial institution server 300 associated with the primary financial institution, via the communications network 106.

After receiving the loan assumption acknowledgment message, at step S518 the primary credit meta-data processor 320 removes the loan from the primary loans management system 322, preferably by providing the primary loans management system 322 with the credit application meta-data and the credit application content. The primary loans management system 322 removes the credit application meta-data and the credit application content from the primary loans database 316.

If the primary credit meta-data processor 320 determines, at step S506, that the credit application is not consistent with the secondary risk requirements of the secondary financial institution, the primary credit meta-data processor 320 may determine from the received credit application meta-data whether the credit application is consistent with the credit risk requirements of the primary financial institution. To do so, the primary credit meta-data processor 320 may compare the received credit application meta-data with the primary credit risk requirements of the primary financial institution that are saved in the risk requirements database 312.

If the primary credit meta-data processor 320 determines from the credit application meta-data that the credit application is consistent with the primary risk requirements of the primary financial institution, the primary financial institution has, in effect, approved the loan. Therefore, the primary credit meta-data processor 320 may register the loan with the primary loans management system 322 of the primary financial institution, preferably by providing the primary loans management system 322 with the credit application meta-data and the credit application content. The primary loans management system 322 may save the credit application meta-data and the credit application content in the primary loans database 316.

If the primary credit meta-data processor 320 determines from the credit application meta-data that the credit application is not consistent with the primary risk requirements of the primary financial institution, the primary credit meta-data processor 320 may notify the vendor, for example, by e-mail, that the credit application has been rejected.

1. A method of transferring a loan, comprising:
(a) a primary financial institution server receiving a credit application for a monetary loan to a credit applicant, the credit application including credit application content and further including credit application meta-data identifying particulars of the credit application, the credit application particulars including a loan amount, the primary financial institution server being associated with a primary financial institution;
(b) the primary financial institution server determining from the credit application meta-data whether the credit application is consistent with secondary credit risk requirements associated with a secondary financial institution, the secondary financial institution being distinct from the primary financial institution; and
(c) after determining from the credit application meta-data that the credit application is consistent with the secondary risk requirements, the primary financial institution server:
(i) registering in a primary loans management system of the primary financial institution a loan in the loan amount to the credit applicant,
(ii) transmitting the credit application content to a secondary financial institution server requesting assumption of the loan by the secondary financial institution, the secondary financial institution server being associated with the secondary financial institution, and
(iii) advancing funds in the loan amount.

2. The method according to claim 1, wherein the advancing funds comprises:
the secondary financial institution server determining from the credit application content whether the credit application is consistent with secondary policy stipulations associated with the secondary financial institution; and
after determining from the credit application content that the credit application is consistent with the secondary policy stipulations:
(iv) the secondary financial institution server registering the loan in a secondary loans management system of the secondary financial institution and transmitting to the primary financial institution server confirmation of the assumption of the loan by the secondary financial institution, and
(v) the primary financial institution removing the loan from the primary loans management system in response to the confirmation.

3. The method according to claim 2, wherein the credit application meta-data comprises at least one of a name of the credit applicant, address of the credit applicant, tax authority identification number of the credit applicant, the loan amount, taxable income of the credit applicant, amount of monetary savings of the credit applicant, and estimated value of assets and liabilities of the credit applicant.

4. The method according to claim 3, wherein the secondary credit risk requirements comprise at least one of minimum credit score, and maximum permitted number of instances late bill payment.

5. The method according to claim 4, wherein the secondary policy stipulations comprise at least one of income statements, wealth reports, and asset valuation reports.

6. The method according to claim 1, wherein the credit application content comprises at least one credit application support document.

7. The method according to claim 6, wherein the credit application content comprises at least one credit application document image derived from the at least one credit application supporting document.

8. A loan transfer network comprising:
a primary financial institution server associated with a primary financial institution, the primary financial institution server being in communication with a primary loans management system; and
a secondary financial institution server associated with a secondary financial institution,
wherein the primary financial institution server is configured to:
(i) receive a credit application for a monetary loan to a credit applicant, the credit application including credit application content and further including credit application meta-data identifying particulars of the credit application, the credit application particulars including a loan amount,
(ii) determine from the credit application meta-data that the credit application is consistent with secondary credit risk requirements associated with the secondary financial institution,
(iii) register in the primary loans management system a loan in the loan amount to the credit applicant,
(iv) transmit the credit application content to the secondary financial institution server requesting an assumption of the loan by the secondary financial institution, and
(v) electronically transfer funds in the loan amount.

9. The loan transfer network according to claim 8, wherein the secondary financial institution server in communication with a secondary loans management system and is configured to:
(vi) determine from the credit application content that the credit application is consistent with secondary policy stipulations associated with the secondary financial institution,
(vii) register the loan in the secondary loans management system, and
(viii) transmit to the primary financial institution server confirmation of the assumption of the loan by the secondary financial institution.

10. The loan transfer network according to claim 9, wherein the primary financial institution server is configured to remove the loan from the primary loans management system upon receipt of the confirmation.

11. The loan transfer network according to claim 8, wherein the credit application content comprises at least one credit application support document.

12. The loan transfer network according to claim 11, wherein the credit application content comprises at least one credit application document image derived from the at least one credit application supporting document.
